(19) United States
(12) Patent Application Publication
(10) Pub. No.: US 2022/0112751 A1
(43) Pub. Date: Apr. 14, 2022

(54) POLY-AXIAL CLOSURE HINGE MECHANISM

(71) Applicant: GMPS INNOVATIONS PTY LIMITED, Brookvale (AU)

(72) Inventors: Gain TIPPER, Beechwood, New South Wales (AU); Steven MARCUS, Dee Why (AU)

(73) Assignee: GMPS INNOVATIONS PTY LIMITED, Brookvale (AU)

(21) Appl. No.: 17/430,042

(22) PCT Filed: Feb. 11, 2020
(86) PCT No.: PCT/AU2020/050112

§ 371 Date: Aug. 11, 2021

(30) Foreign Application Priority Data
Feb. 11, 2019 (AU) 2019900430

(51) Int. Cl. E05D 11/10; E05D 3/12

(52) U.S. Cl. CPC E05D 11/1007; E05D 3/12; E05Y 2900/132; E05Y 2900/131; E05Y 2900/148; E05Y 2800/262

(57) ABSTRACT

A poly-axial closure hinge includes a primary hinge assembly and a secondary hinge assembly having a second pivot axis being substantially parallel to and spaced apart from the primary hinge axis. A hinge locking assembly configured to fix movement of the primary and secondary hinges relative to each other about the secondary pivot axis when moved from the closed position and allow limited movement of the secondary hinge relative to the primary hinge when in the closed position.

### FIELD OF THE INVENTION

The invention relates to a poly-axial hinge mechanism and, in particular, to a poly-axial hinge mechanism to support and define a movement path of a closure fitted to a captive frame and closure installation.

The invention has been developed primarily with respect to doors fitted to a captive doorframe and will be described hereinafter with reference to this application. However, it will be appreciated that the invention is not limited thereto and is applicable to other closures fitted to captive frames such as windows, hatches and portals, for example.

### BACKGROUND OF THE INVENTION

Captive hinged door systems are a relatively new development in physical security. A door is held captive from opening by both a hinge stile frame and an opposed latch stile frame whereby a door can be swung open once clear of the latch stile frame. While the captive hinged door systems maintain a conventional hinged action to move between the open and closed positions, to close and secure a captive door first requires the door to swing into a closed position against the doorframe, and then move sideways to “capture” the door with the two door stile members then residing in two corresponding channel sections formed into the doorframe structure, so as to prevent the door from swinging open. The door can be opened by first sliding the door sideways so it is no longer held “captive” within the doorframe, and then the door can swing open.

A captive hinged door system has a door of the appropriate size and structure to connect the hinge mechanism and operate into and out of the doorframe as required. The system further requires the captive doorframe that includes two capture channels formed into the frame structure as well as a multi-axial hinge mechanism to connect the door to the doorframe and allow the door to move with the required swing and linear actions. In practice, a movement control mechanism is required to guide and limit movement of the door.

The captive doorframe incorporates two opposing channel sections. The “hinge stile channel” is formed into the doorframes' “hinge stile member” and the “capture stile channel” is formed into the opposing “capture stile member”. The two channels are shaped so that when the door is closed against the doorframe and secured within said channels, the door is in the “closed captive” position. The two opposing channel sections surround the full length of the opposing edge surfaces and a portion of their respective adjoining side surfaces of the door's hinge stile and capture stile. In the “closed captive” position any load applied to a door to force it in an inward or outward direction, is transmitted directly to the capture channels and thereby to the entire doorframe structure and not upon the lock or hinge mechanism.

With a captive doorframe, the shape of the capture channel sections allow the door that is closed against the doorframe stop member and not engaged in the capture stile channel section to be in the “closed non-captive” position, to move in a linear direction to enter and leave the capture stile channel section, while remaining in the doorframe's hinge stile channel. The hinge stile channel shape further allows a closed door that is in the “closed non-captive” position, where the door is closed against the doorframe stop member and the door's capture stile is not located within the doorframe's capture stile channel, to swing to the open position, and in so doing move the door hinge stile out of captivity within the doorframe hinge stile member channel, and thereafter, swing back to the closed non-captive position where the door covers the doorframe opening and the door “hinge” stile is again captive within the doorframe hinge stile channel section, and then further allow the door to move in a linear direction to return the door's “capture” stile to captivity within the frames “capture” stile channel.

A poly-axial hinge mechanism is described in International Patent Application No. PCT/AU2016/050656 where a hinge mechanism includes three pivot axes or hinges that produce no defined door movement parameters, so the hinge function is limited to connecting the door to the doorframe in such a manner as to support the door to allow the door to move with both the required linear sliding and rotational actions to engage with and disengage from the captive doorframe.

With the captive hinged door system of the type described in the International Patent Application No. PCT/AU2016/050656 the door operating parameters and movement path are controlled and defined by the combination of the door's contact with the doorframe structure and the door movement guidance mechanism that is an independent mechanism affixed between the door and doorframe structures.

With the captive hinged door system of the type described in the International Patent Application No. PCT/AU2016/050656 the door relies entirely upon the separate door movement guidance mechanism to define the door's operating path to allow the door to swing open and closed with a conventional hinged door action. The mechanism further causes the door to correctly leave and enter the captive hinge stile channel section when the door is swung to the opened and closed positions respectively. The separate door movement guidance mechanism is further responsible for controlling when the door's sliding action can occur. The guidance mechanism restricts the door's sideways sliding motion to only occur when the door is closed against the doorframe or the door's sideways movement is constrained by part of the door's outer capture stile residing within the doorframe structure and thereby having the movement limited by the doorframe capture stile member.

Unfortunately, this prior known mechanism is relatively complex and is understood to not insignificantly add to the cost of a captive door installation. Furthermore, that mechanism is believed to be unnecessarily vulnerable to attack and damage which would prevent its use in many security conscience situations.

### Genesis of the Invention

The genesis of this invention is a desire to provide a poly-axial hinge for a hinged closure such as a door in a captive frame closure system that overcomes one or more of the disadvantages of the prior art, or to provide a useful alternative.

### SUMMARY OF THE INVENTION

According to an aspect of the invention there is provided a poly-axial closure hinge comprising:

a primary hinge assembly defining a primary pivot axis and configured to extend intermediate a closure head frame and a lower end proximal to a floor surface, the primary hinge configured to have a closure rotatably mounted thereto such that the closure is movable thereabout between a closed position covering an opening and an open position;

a secondary hinge having a secondary pivot axis defined by the primary hinge and configured to extend along or proximal to an edge of the closure, the second pivot axis being substantially parallel to and spaced apart from the primary hinge axis; and

a hinge locking assembly configured to fix movement of the primary and secondary hinges relative to each other about the secondary pivot axis when moved from the closed position and allow limited movement of the secondary hinge relative to the primary hinge when in the closed position, the hinge locking assembly including:
a rotatably mounted hinge locking plate movable between a locked position and an unlocked position in response to the primary hinge and secondary hinge rotation about the secondary pivot axis, the hinge locking plate including a locking pin recess;
a locking pin fixed with respect to the primary hinge assembly and spaced apart from the secondary pivot axis, the locking pin configured to reside within the hinge locking plate recess to limit the orientation of the primary hinge relative to the secondary hinge when moved from the closed position; and
a rotatably mounted hinge locking plate arm movable between a locked and unlocked position in response to rotation of the primary hinge about the primary pivot axis from the closed position.

In preferred embodiments, the secondary pivot locking assembly includes a latch operating arm being rotatably mounted to the primary hinge and configured for movement caused by a cam plate that is disposed about the primary pivot axis, and whereupon rotation of the primary hinge about the primary axis causes the latch operating arm to move between the engaged and disengaged positions. Moving the latch operating arm to the engaged position causes the associated latch arm to move to the latch engaged position, and moving the latch operating arm to the disengaged position will cause the associated latch arm to move to the latch disengaged position. The latch operating arm is moved to the engaged position when the hinge is moved away from the closed position, and moves to the disengaged position when the hinge is in the closed position.

In preferred embodiments, the secondary pivot locking assembly further includes a latch arm being rotatably mounted to the primary hinge and configured for movement caused by the latch operating arm. When the latch arm is moved to the latch engaged position by the latch operating arm, the latch arm will move to the proximity of the locking plate locking arm and thereby prevent the hinge locking plate locking arm from disengaging with the hinge locking plate, and when the latch arm is moved to the latch disengaged position, the latch arm moves under the effect of the return spring to the latch disengaged position where the hinge locking plate locking arm can move to a position where it is disengaged from the hinge locking plate.

In preferred embodiments, the secondary pivot locking assembly further includes a hinge plate locking arm being rotatably mounted on the secondary hinge and movable between the locked position wherein the said hinge plate locking arm is engaged with the hinge locking plate and thereby prevents the hinge locking plates rotation about its pivotal mounting, and the unlocked position wherein the hinge plate locking arm is spaced apart from the hinge locking plate and thereby allows the hinge locking plate to rotate about the said plate pivotal mounting. More preferably, the hinge locking arm is caused to move to and from the locked and unlocked positions by the hinge rotation about the primary axis, and where the hinge moves away from the closed position, the hinge locking arm moves to the locked position and thereby engaged with the hinge locking plate.

In preferred embodiments, the secondary pivot locking assembly includes a hinge locking plate that is rotatably mounted to the secondary lock and is movable between the locked position where the locking arm can be engaged and prevents the locking plate's rotational movement and the unlocked position where the locking arm cannot be engaged with the hinge locking plate and thereby allowing the locking plate to rotate. Further the hinge locking plate includes a locking pin recess to allow the locking pin to move within when the secondary hinge moves rotationally relative to the primary hinge about the secondary axis, and thereby when the hinge locking plate is not in the locked position, cause the hinge locking plate to rotate about the rotational mounting. With the hinge locking plate in the locked position with the locking arm engaged to prevent the locking plate rotating, the locking pin is held in a fixed position within the locking pin recess and thereby prevents the rotational movement about the second axis of the secondary hinge assembly relative to the primary hinge until the locking arm is disengaged from the hinge locking plate to thereby allow the hinge locking plate to rotate and thereby allow the locking pin to move within the locking pin recess when the primary hinge moves relative to the secondary hinge about the secondary axis.

In preferred embodiments, the hinge locking plate assembly includes a latch operating arm configured for movement between a locked position causing said hinge locking plate locking arm to lock the hinge locking plate and an unlock position wherein the latch operating arm is moved clear of the hinge locking plate locking arm; a latch operating arm rotatably mounted and movable between an unlock position wherein said hinge locking plate locking arm is spaced apart from the hinge locking plate and a locked position wherein the hinge locking plate locking arm locks the hinge locking plate, the latch operating arm moving between the locked and unblocked positions in response to rotation about the primary hinge. More preferably, the latch operating arm is moved by a cam plate disposed about the primary hinge.

Preferably, a roller guide disposed on a marginal edge of the closure such that when the closure is in the closed position the roller guide is adjacent a roller disposed on and extending from an adjacent closure frame. As the closure moves from the closed non-captive position to the open position the roller guide surface that is approximately tangential to the primary pivot axis will cause the closure to move to the position where the hinge locking plate locking arm can engage with the hinge locking plate as the closure opens.

More preferably, the latch operating arm and the latch arm are resiliently biased into the unlocked position, and when the closure in the closed position the hinge locking plate locking arm can be moved to the unlocked position. It is noted that in order to allow the door to move a first requirement is that the two arms are to be in the unlocked position. This allows the locking arm to be moved into the unlocked position and thereby allow the door to move sideways

Also preferably, the hinge locking plate locking arm is resiliently biased to the locked position, and when the closure is in the closed position, the hinge plate locking arm is moved to the unlocked position and allows the limited movement of the closure in the plane thereof.

Also preferable, the primary hinge is pivotally mounted to, or adjacent to, a closure frame hinge stile and includes an elongate torque bar extending from an upper end at or adjacent the closure frame head to a lower end at or adjacent a closure frame lower end and where the torque bar maintains the upper and lower extremities of the secondary pivot axis in the primary hinge parallel to and separate from the primary pivot axis.

It can therefore be seen there is advantageously provided a poly-axial closure hinge for a captive closure frame provides an integrated structure or integrated mechanism that provides a restraint or otherwise controls the door (or other closure) movement by controlling the movement of one or more of the hinge pivot axes so that the door moves within the defined operating parameters that are required to make the door function as described above. Further, the poly-axial closure hinge produces defined door movement parameters so the hinge function is limited to connecting the door to the doorframe in such a manner as to supporting the door to causes the door to be moved within the defined parameters for both the required linear sliding and rotational actions.

Yet further, poly-axial hinge mechanism of the preferred embodiments advantageously controls the door movement path in such a manner that the door can swing in either direction about a single axis between the open position and closed non-captive positions in a defined path that is in the same or similar manner to a conventionally hinged door without the door having the ability for an additional linear movement action until the door is in a position covering the doorframe opening and closed against the doorframe stop, or in a position where the doorframe capture stile member will limit the door's linear movement. It will also be appreciated the poly-axial hinge, controls the door during the opening or closing movement to allow the door hinge stile to move into and out of containment within the doorframe hinge stile channel member without being reliant upon contact with the said hinge stile channel member.

It will be further appreciated that where the preferred embodiments provide an integrated door movement control mechanism in addition to providing the closure (or door in the preferred embodiments) support functions to enable the door to have a simultaneous single planar rotational and linear movement. The hinge mechanism further advantageously provides the required door guidance and operating features so the door moves within defined parameters that allow the door to rotate as required to move in either direction between the open and closed positions, as well as allow the door to have a linear movement only when the door is positioned within the confines of the doorframe structure or and closed against the doorframe so the door can move into, and out of, the closed captive position where the door stiles reside within the doorframe capture channel members.

### BRIEF DESCRIPTION OF THE DRAWINGS

A preferred embodiment of the invention will be described, by way of example, with reference to the accompanying drawings in which:

FIG. 1 is an elevated perspective view of a door and doorframe having a poly-axial hinge mechanism according to a preferred embodiment being attached to a door mounted in a captive doorframe where the door is in a partially open position;

FIG. 2 is an elevated perspective view of the hinge of FIG. 1 affixed to a section of the doorframe hinge stile member and affixed to the door that is in the closed non-captive position;

FIG. 3 is an elevated perspective view of the hinge of FIG. 1;

FIG. 4 is an elevated perspective view of part of the hinge of FIG. 3;

FIGS. 5 to 8 are perspective views of components of the hinge of FIG. 4;

FIGS. 9 to 11 show a closure with part of the mechanism of FIG. 1;

FIG. 12 is a sectional plan view of the hinge of FIG. 1 with the door in the closed captive position;

FIG. 13 is a sectional plan view of the hinge of FIG. 1 with the door in the closed non-captive position;

FIG. 14 is a sectional plan view of the hinge of FIG. 1 with the door in the partially open position with the door capture stile still residing partly within the doorframe structure;

FIG. 15 is a sectional plan view of the hinge of FIG. 1 according to the preferred embodiment with the door in the partially open position; and

FIG. 16 is a sectional plan view of the hinge of FIG. 1 according to the preferred embodiment with the door in the open position.

### DETAILED DESCRIPTION

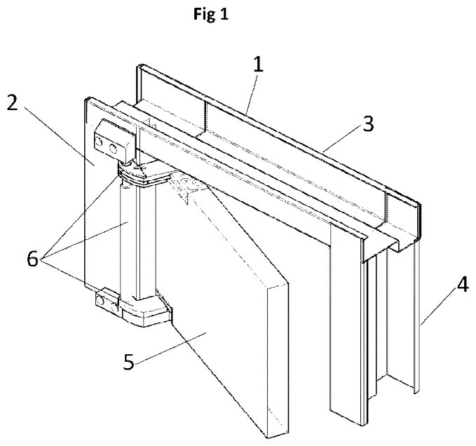

Referring to the drawing generally, like reference numerals are used to denote like components unless otherwise noted. In FIG. 1 particularly, the poly-axial control hinge mechanism 6 is rigidly attached to the doorframe 1 and door 5. The door 5 is in the partially open position.

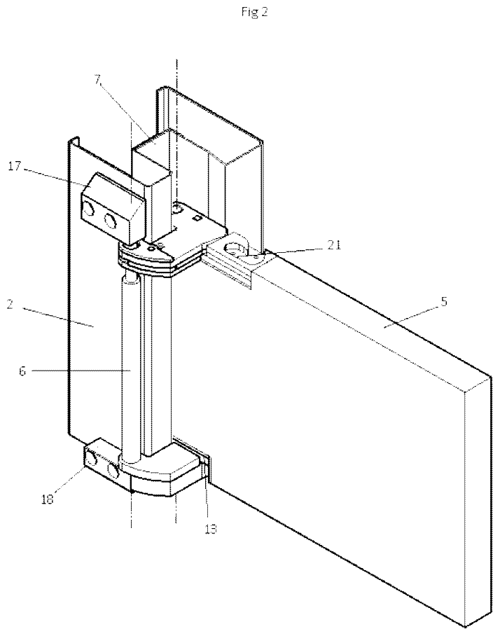

Referring also to FIG. 2, a multiaxial control hinge mechanism 6 is rigidly affixed to the captive doorframe 1 and the door 5. The door 5 is in the closed non-captive position.

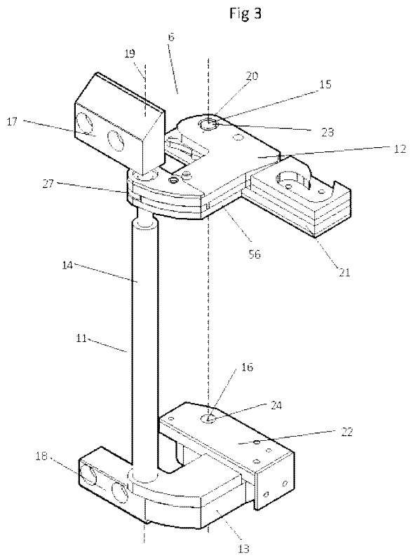

Referring to FIG. 3, the multiaxial control hinge mechanism 6 comprises three pivotally joined hinge sub-assemblies being the doorframe pivot assembly consisting of the upper primary pivot block 17 and lower primary pivot block 18 and further include the intermediate sub assembly being the primary hinge sub assembly 11 and further including the secondary hinge assembly consisting of the upper door pivot plate assembly 21 and lower door pivot assembly 22. Further doorframe pivot assembly is rigidly affixed to the captive doorframe hinge stile member 2 (not shown). Further the intermediate sub assembly being the primary hinge sub assembly 11 is pivotally affixed to the doorframe pivot assembly on the primary pivot axis 19 and the secondary hinge assembly on the secondary pivot axis 20. Further the secondary hinge assembly is rigidly affixed to the door where the upper door pivot plate assembly 21 is affixed in a position that is at, or adjacent to, the door hinge stile member, and the lower door pivot assembly 22 is rigidly affixed to the bottom of a door in a position that is at, or adjacent to, the door hinge stile member. Further, the primary pivot axis 19 and secondary pivot axis 20 are parallel and spaced apart by a predetermined distance. Rotation of the upper door pivot plate assembly 21 about the secondary pivot axis 20 is controlled by the hinge locking mechanism having the hinge locking pin 30 and the hinge locking plate 43 and the locking arm 47.

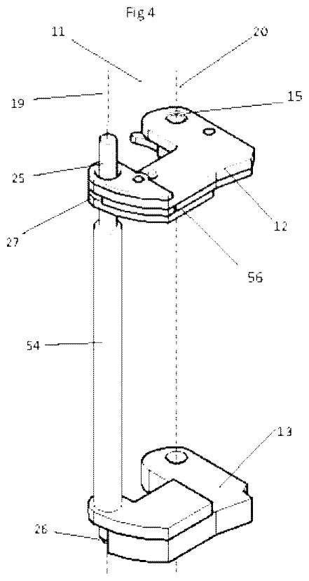

Referring to FIG. 4, the primary hinge sub assembly 11 comprises the torque bar assembly 54 being constructed of metal components and where at the top extremity provides a shaft to pivot within the block 17 and at the other extremity provides a shaft to rotate within the block 18. Further the torque bar assembly 54 has the upper primary hinge plate assembly 12 rigidly affixed to the torque bar assembly 54 towards the top extremity and the lower primary hinge plate assembly 13 rigidly affixed towards the other extremity. The structure of the primary hinge torque bar 14 is to be such as to maintain the upper door pivot housing 15 and lower door pivot housing 16 on the common secondary pivot axis 20 by overcoming the torsional and other distortive forces applied upon the said bar by the plate assemblies 12, 13 (not shown).

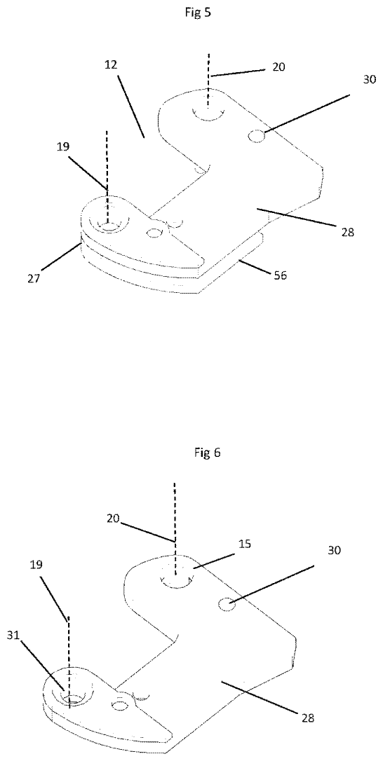

Referring to FIG. 5, the upper primary hinge plate assembly 12 is constructed from metal components that include the upper coupling plate 28 and the primary hinge latch assembly 56. The said assembly 12 further includes the latch operating cam 27 that is rotationally affixed to assembly 12 so that the cam 27 remains in a static position relative to the doorframe (not shown) when the said assembly 12 rotates about primary pivot axis 19 relative to the captive doorframe hinge stile member 2.

Referring to FIG. 6, the upper coupling plate 28 includes a circular housing 31 to rigidly affix the said plate 28 to the torque bar 14 (not shown) and further includes the upper door pivot housing 15 to allow the pivotal coupling with the upper door pivot assembly 21 by the upper door pivot pin 40. The plate 28 further includes the hinge locking pin 30 rigidly affixed in a position to engage with the hinge locking plate 43 (not shown).

Referring to FIG. 7, the primary hinge latch assembly 56 includes the latch assembly base plate 29 incorporates the upper hinge torque bar housing 31 to rigidly affix the said plate 29 to the torque bar assembly 54 at a distance from the upper coupling plate 28 so that the arm 35 and arm 33 can operate as required, and have the assembly 56 further include the latch operating arm pivot pin 34 rigidly affixed to the plate 29 to allow the latch operating arm 35 to rotate about, and further include the latch arm Pivot pin 33 rigidly affixed to the plate 29 to allow the latch arm 33 to rotate about. The latch spring 36 is connected between the plate 29 and the arm 33 to provide a biased movement of the latch arm 33 away from engagement with the locking arm locking arm 47 (not shown) and further cause contact with one end of the latch operating arm 35 and thereby cause said arm 35 to rotate about pin 34 and in so doing cause the latch operating arm contact surface 53 to maintain contact with the latch operating cam 27 (not clearly shown).

Referring to FIG. 8, the lower primary hinge plate assembly 13 is constructed from metal components but can be constructed from suitably composed plastic or composite materials. This is applicable to all components where required strength of component can determine their composition. The assembly 13 is rigidly affixed to the primary hinge torque bar 14 at the lower hinge torque bar housing 37. The assembly 13 further includes the lower door pivot housing 38 to allow the pivotal coupling of the lower door pivot plate 51 via the lower door pivot pin 50.

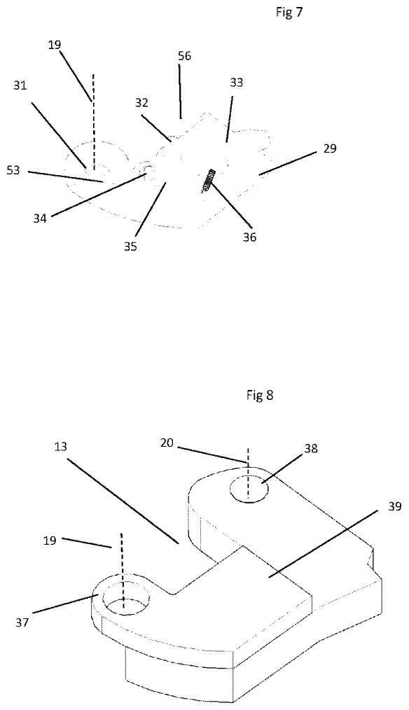

Referring to FIG. 9, the upper door pivot assembly 21 is rigidly affixed to the top of the door 5 above the door hinge stile member and where the upper door pivot pin 40 is positioned on the secondary pivot axis 20 and the lower door pivot assembly 22 is rigidly affixed to the bottom of the door 5 below the door hinge stile member and where the lower door pivot pin 41 is positioned on the secondary pivot axis 20.

Referring to FIG. 10, the upper door pivot assembly 21 is a metal structure that is to be rigidly affixed to the door 5 (not shown). The said assembly 21 includes the upper door pivot pin 40 to pivotally engage with the upper door pivot housing 15 (not shown) and the rigidly affixed hinge locking plate pivot pin 44 to pivotally engage with the hinge locking plate 43, and the rigidly affixed locking arm pivot pin 46 to pivotally engage with hinge locking arm 47, all pivot pins being rigidly affixed to said assembly 21. Further the said assembly includes a hinge locking mechanism consisting of the hinge locking pin being rigidly mounted to the upper hinge plate assembly 12 (not shown) and the hinge locking plate 43 and the locking arm 47. Further, the hinge locking plate 43 includes a locking pin capture recess 42 to slidably engage with the hinge locking pin 30, and further include the locking arm 47 being pivotally affixed by the pin 46 and where one end of the arm 47 includes a surface to enable engagement contact with the inside face of the doorframe hinge stile capture channel 7, and the other end to incorporate a catch member to engage with the hinge locking plate catch surface 48. One end of the locking arm spring 49 is connected to the catch end of the locking arm 47, and the other end of the spring is connected to the pivot assembly 21 base. Further the assembly includes the roller guide recess 45 to engage with a roller attached to the doorframe head member 3 (not shown), and where the recess 45 is shaped to only allow the door to swing towards the open position until the door has moved in a linear manner from the closed captive position to the closed non-captive position and thereby ensure the locking arm 47 will engage with the hinge locking plate catch surface 48 and thereby prevent any further linear movement of the door away from the Primary pivot axis 19.

Referring to FIG. 11, the lower door pivot assembly 22 is a metal structure that is to be rigidly affixed to the door 5 (not shown). The assembly 22 includes the lower door pivot pin 50 being rigidly affixed to the assembly 22 and where the lower door pivot assembly 22 is to pivotally engage with the lower door pivot housing 38.

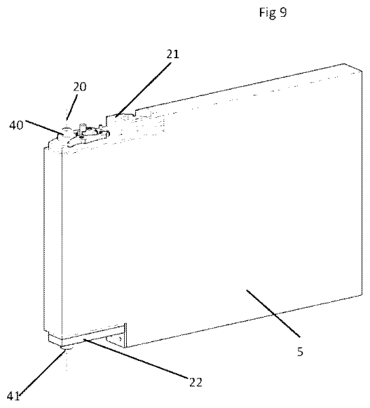

FIGS. 12-16 show the various component positions and configurations when the door moves from the closed captive configuration where the door 5 covers the doorframe aperture and the two door stile members 9 and 10 are located within the two doorframe capture channels 7 and 8 to an open position where the door 5 does not cover the doorframe aperture and neither door stile members 9 and 10 is not located in their respective doorframe capture channels 7 and 8. More particularly, FIG. 12 shows the door 5 has moved in a linear action against the doorframe head member 3 (not shown) from the closed non-captive position to be shown in the closed captive position where the door 5 has covered the doorframe aperture and the door hinge stile member 9 is residing in the doorframe hinge stile channel 7 and the door capture stile member 10 is residing within the doorframe capture stile channel 8.

When the door 5 moves in a linear action to and from the closed non-captive and captive positions, the locking arm operating surface 52 maintains contact with the inside face of the doorframe hinge stile capture channel 7 and thereby causes the locking arm 47 to maintain the position of disengagement from the locking plate catch surface 48. The door 5 movement to the closed captive position has caused the primary hinge sub assembly 11 to rotate about the secondary pivot axis 20 relative to the secondary hinge to the shown position and thereby cause hinge locking pin 30 to move within the locking pin capture recess 42 and thereby cause the hinge locking plate 43 to rotate about the hinge locking plate pivot pin 44.

Further, the door 5 movement to the closed captive position has caused the primary hinge latching sub assembly 11 to rotate about the primary pivot axis 19 so the latch operating arm contact surface 53 makes contact with the latch operating cam 27 at a position so the latch operating arm 35 can rotate about the latch operating arm pivot pin 34 and thereby allow the latch arm 33 to reside in a position where it allows the locking arm 47 to maintain the position where it cannot latch with the hinge locking plate catch surface 48.

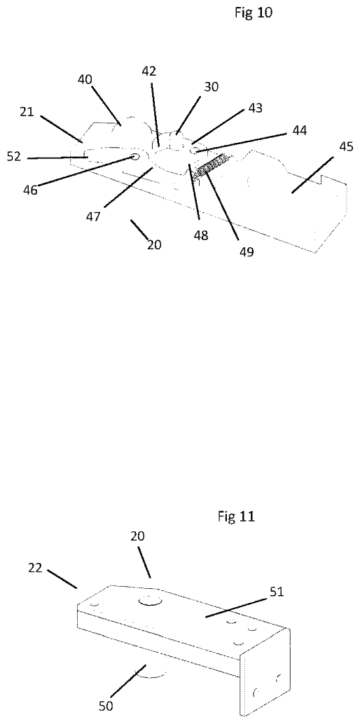

Referring to FIG. 13, the door 5 has moved in a linear action against the doorframe head member 3 (not shown) from the closed captive position to be in the closed non-captive position where the door 5 has covered the doorframe aperture and the door hinge stile member 9 is residing in the doorframe hinge stile channel 7 and the door capture stile member 10 is not residing within the doorframe capture stile channel 8. When the door 5 moves in a linear action to and from the closed non-captive and captive positions, the locking arm operating surface 52 maintains contact with the inside face of the doorframe hinge stile capture channel 7 and thereby causes the locking arm 47 to maintain the position of disengagement from the locking plate catch surface 48. The door 5 movement to the closed non captive position has caused the primary hinge sub assembly 11 to rotate about the secondary pivot axis 20 to the shown position and thereby cause hinge locking pin 30 to move within the locking pin capture recess 42 and thereby cause the hinge locking plate 43 to rotate about the hinge locking plate pivot pin 44 to the position where when the door swings towards the open position the locking arm 47 can move under the influence of the locking arm spring 49 to engage with the hinge locking plate catch surface 48.

Further, the door 5 movement to the closed non-captive position has caused the primary hinge sub assembly 11 to rotate about the primary pivot axis 19 so the latch operating arm contact surface 53 maintains contact with the latch operating cam 27 at a position so the latch operating arm 35 can rotate about the latch operating arm pivot pin 34 and thereby allow the latch arm 33 to reside in a position where it allows the locking arm 47 to be in the position where it cannot latch with the hinge locking plate catch surface 48 Further, from the closed non-captive position, the door 5 can swing about the primary pivot axis 19 towards the open position.

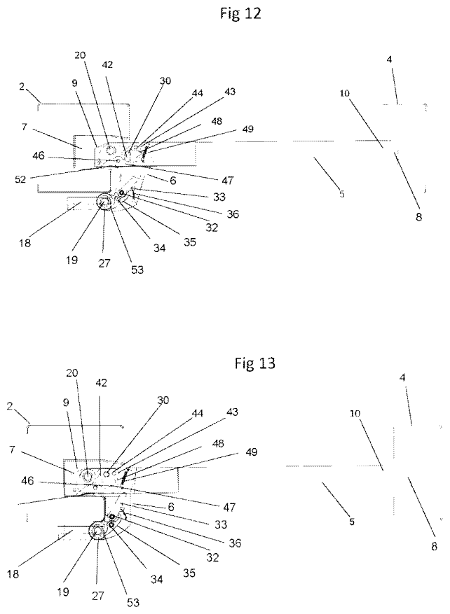

Referring to FIG. 14, the door 5 has moved in a rotation action about primary pivot axis 19 away from the doorframe head member 3 (not shown) towards the open position, while the door hinge stile member 9 is residing in the doorframe hinge stile channel 7 and the door capture stile member 10 is not residing within the doorframe capture stile channel 8, but is still partially within the doorframe structure.

Further, as the door moves away from the closed non-captive position towards the open position, the doorframe head guide roller 55 (not shown) that is affixed to the captive doorframe head member 3 moves within the roller guide recess 45 to cause the door 5 to rotate about primary pivot axis 19 in a position so the locking arm 47 can engage with the hinge locking plate catch surface 48. The said roller 55 will disengage from the roller guide recess 45 as the door swings further open. As the door moves away from the closed non-captive position towards the open position, the multi-axial control hinge mechanism 6 rotates about the primary pivot axis 19 and thereby causes the locking arm pivot pin 46 and locking arm operating surface 52 to move away from the doorframe hinge stile capture channel 7 side surface, which allows the locking arm spring 49 to causes the locking arm 47 to rotate about locking arm pivot pin 46 and thereby engage the locking arm catch with the hinge locking plate catch surface 48, and in so doing prevent the hinge locking plate 43 rotating about the hinge locking plate pivot pin 44 and thereby with the hinge locking pin 30 engaged within the locking pin capture recess 42, the upper door pivot assembly 21 is locked and unable to rotate about secondary pivot axis 20 to maintain its current position relative to the primary hinge sub assembly 11 until the locking arm 47 is disengaged from the hinge locking plate catch surface 48. The door 5 rotational movement towards the open position has caused the primary hinge sub assembly 11 to rotate about the primary pivot axis 19 so the latch operating arm contact surface 53 maintains contact with the latch operating cam 27 at a position to cause the latch operating arm 35 to rotate about the latch operating arm pivot pin 34. This causes the latch arm 33 to move to a position where it allows the locking arm 47 to move towards the position where it will prevent the latch arm 33 from disengaging from the hinge locking plate catch surface 48. Further, from the position shown the door 5 can swing about the primary pivot axis 19 towards the open position.

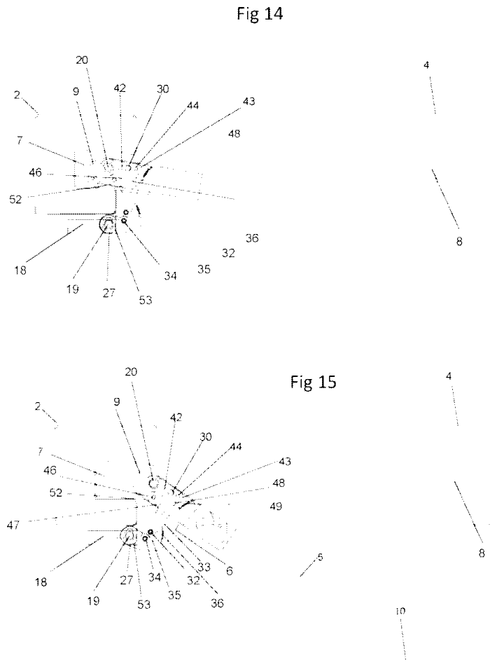

Referring to FIG. 15, the door 5 has moved in a rotation action about primary pivot axis 19 by 34 degrees away from the doorframe head member 3 (not shown) towards the open position. The door hinge stile 9 is not engage with the doorframe hinge stile capture channel 7. Further, the multi-axial control hinge mechanism 6 provides the door with a rotation motion about primary pivot axis 19 that has allowed the door hinge stile 9 to disengage with and move away from the doorframe hinge stile capture channel 7 and then when the door is moved towards the closed position from the position shown, will allow the door hinge stile 9 to enter and engage with the doorframe hinge stile capture channel 7. The secondary pivot axis 20 remains locked with the hinge locking pin 30 engaged within the hinge locking plate 43 and the locking arm pivot pin 46 is engaged with the hinge locking plate catch surface 48. The door 5 rotational movement towards the open position has caused the primary hinge sub assembly 11 to rotate further about the primary pivot axis 19 so the latch operating arm contact surface 53 maintains contact with the latch operating cam 27 at a position to cause the latch operating arm 35 to further rotate about the latch operating arm pivot pin 34 and thereby cause the latch arm 33 to move further into a position where it prevents the locking arm 47 from disengaging from the hinge locking plate catch surface 48. Further, from the shown position the door 5 can swing about the primary pivot axis 19 towards the open position.

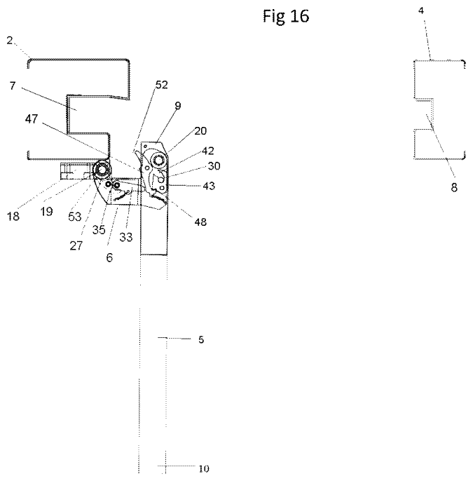

Referring to FIG. 16, the door 5 has moved further in a rotation action about primary pivot axis 19 to be in the open position where the secondary pivot axis 20 remains locked and the door is prevented from having a linear movement action and the latch operating arm contact surface 53 remains in contact with the latch operating cam 27 to thereby maintain the latch arm 33 in a position to prevent the locking arm 47 disengaging from the hinge locking plate catch surface 48 according to FIG. 14 description.

From the foregoing, it can be seen preferred embodiments provide a poly- or multi-axial closure hinge mechanism having a pair of pivot or hinge assemblies to create a mechanism with two parallel pivot axes being the primary and secondary axes, and where the mechanism supports and controls the door's movements to allow the door to rotate about a defined axis to allow the door to swing between the open and closed positions on a defined path and further provide the door with slidable movement control that will not allow the door to move sideways in the plane of the door intermediate the capture stiles of the doorframe. This changes (increases) the radial distance from the centre of the primary pivot axis to the outer marginal edge of the door stile member until the door is in a position to move sideways between the captive and non-captive positions. In other words, preferred embodiments provide a multiaxial movement control hinge mechanism that has the doorframe pivot assembly consisting of the upper and lower primary pivot blocks being rigidly affixed to the outer surface or adjoining structure of the doorframe's hinge stile member and pivotally affixed to the primary hinge assembly on the primary pivot axis. The multiaxial movement control hinge mechanism has the primary hinge sub assembly pivotally affixed on the secondary pivot axis to the secondary hinge assembly consisting of the upper door pivot plate assembly and the lower door pivot plate assembly. Further the upper door pivot plate assembly is rigidly affixed to the top of a door in a position that is at, or adjacent to, the door hinge stile member, and the lower door pivot plate assembly is rigidly affixed to the bottom of a door in a position that is at, or adjacent to, the door hinge stile member. The primary and secondary pivot axes are parallel and spaced apart at a determined distance.

Preferred embodiments also provide a poly-axial closure hinge mechanism that has the structure to support the door and allow the door to move rotationally and move sideways so that the door remains correctly aligned with the doorframe, and to allow the door to swing between the open and closed non-captive positions on a rotational axis. Where the door open position is when the door hinge stile member does not reside within the doorframe hinge stile capture channel and the door does not cover the doorframe opening and further the closed non-captive position is where the door covers the doorframe opening with the door closed against the doorframe head member internal stop surfaces and the door hinge stile resides within the doorframe hinge stile capture channel and the door capture stile member is not engaged within the doorframe capture stile capture channel. Further the invention structure allows the door to move sideways in a linear action that is parallel to the doorframe head's longitudinal axis, from the closed non-captive position to the closed captive position where the door capture stile resides within the doorframe capture stile channel section, and further, then allows the door to move back to the closed non-captive position.

It can be seen that a preferred poly-axial closure hinge mechanism includes the integrated door movement control mechanism consisting of the hinge locking mechanism that locks and unlocks the primary hinge sub assembly and secondary hinge assembly to prevent or allow them to rotate about the secondary pivot axis and thereby. When locked, the integrated door movement control mechanism prevents linear door movement when the door moves away from the doorframe head stop member and thereby allows the door to swing in either direction between the open and closed positions on a defined path that replicates a normal hinged door action. Further when the door is in the position where it is closed against the doorframe head member stop and thereby unlocking the integrated door movement control mechanism to allow the door to have a linear movement in either direction between the closed captive and the closed non-captive positions. To allow the door to move between the open and closed positions requires the door to only pivot about the primary pivot axis, while the secondary pivot axis is locked by the hinge locking mechanism so the upper door pivot plate assembly cannot rotate about the secondary pivot axis relative to the primary hinge sub assembly. Further for the door to move in a linear action requires the primary hinge sub assembly to rotate about the primary pivot axis and the secondary pivot axis is to be unlocked so both the primary hinge sub assembly and the secondary hinge assembly can rotate relative to each other about the secondary pivot axis.

In preferred embodiments, the integrated movement control mechanism controls the door pivot angle about the secondary pivot axis between to the primary hinge sub assembly and the upper door pivot plate assembly elements that are affixed to the door structure and the other corresponding secondary hinge assembly elements that are attached to the door structure, so that during the door swing action from the closed position towards the open position the door will rotate only about the primary pivot axis to enable the door to leave the doorframe hinge stile channel section without contact with the said hinge stile capture channel section, and then during the door's return movement to the closed non captive position, to cause the door hinge stile to enter and then reside within the doorframe hinge stile capture channel without the door hinge stile becoming in contact with the doorframe hinge stile capture channel section.

In preferred embodiments, the integrated door movement control mechanism ensures the poly-axial closure hinge mechanism operates the door within the required operating parameters by controlling the distance and position between the door hinge stile member and the doorframe hinge stile capture channel and other elements of the hinge stile member, when the door moves between the closed and open positions and in return. Further the said multiaxial movement control hinge mechanism controls the position of the door relative to the doorframe's hinge capture channel's internal side surfaces during the door's linear movement within the doorframe capture channels. Further, the said multiaxial movement control hinge mechanism allows when required, the door to move in a linear direction to have the door capture stile engage with or disengage from the doorframe capture channel.

Preferred embodiments of the poly-axial hinge mechanism is to be used in conjunction with a door or other type aperture closing device and a captive doorframe that preferably includes both hinge stile and capture stile members that include an appropriately shaped channel section with opposing openings to capture a door in such a manner as to provide the required movement and security and structural functions.

Preferably, the poly-axial movement control hinge mechanism includes a primary hinge sub assembly rotatably coupled to the doorframe and two door pivot plate assemblies that are rotationally coupled to the primary hinge sub assembly and rigidly coupled to the door structure to allow a door to move with both a controlled lateral sideways movement between the captive and non-captive positions and a swing movement to move between the open and closed positions. In such preferred embodiments, the primary hinge sub assembly has a substantially longitudinally extending hinge torque bar extending between an upper end and a lower end; an upper pivot shaft disposed at or adjacent the upper end of the primary hinge torque bar; an upper frame mounting block disposed at or adjacent the upper end of the upper pivot shaft; an upper hinge plate assembly disposed adjacent the upper end of the primary hinge torque bar assembly; an upper hinge plate assembly adapted to produce a pivot housing to receive the upper door pivot plate assembly pivot pin and thereby rotate within; and upper hinge plate assembly to include a rigidly mounted locking pin at a prescribed distance from the secondary axis an in a position to engage with the hinge locking plate locking pin capture recess. Also included is an upper hinge plate latching mechanism adapted to operate in responsive to the door opening angle to allow or prevent the hinge locking mechanism to unlock and thereby allow the primary hinge sub assembly and secondary hinge assembly to rotate about the secondary pivot axis; a lower pivot shaft disposed at or adjacent the lower end of the primary hinge torque bar; a lower frame mounting block disposed at or adjacent the bottom end of the lower pivot shaft; a lower hinge plate assembly disposed adjacent the lower end of the primary hinge torque bar assembly; and a lower hinge plate assembly adapted to produce a pivot housing to receive the lower door pivot plate assembly pivot pin and thereby rotate within. Further, the upper door pivot plate assembly has a plate structure to form a rigid assembly with which to a rigidly affix to the door and to affix other components which includes an upper door pivot pin which is rigidly affixed and adapted to rotationally engage with the upper door pivot housing and thereby rotationally affix to the upper hinge plate assembly. Further the upper door pivot plate assembly having a locking mechanism to engage with the upper hinge plate assembly to prevent rotation about the secondary axis of the upper door pivot pin within the upper hinge plate door pivot pin housing; a locking mechanism that operates in response to the position of the upper door pivot plate assembly in relation to the doorframe hinge stile capture channel; a guide assembly to cooperate with the doorframe assembly to correctly position the upper door pivot plate assembly within the doorframe capture channel: a lower door pivot plate assembly and has a plate structure to form a rigid assembly with which to affix to the door and to which affix other components including a rigidly mounted lower door pivot pin adapted to rotationally affix to the lower hinge plate assembly.

Description of Reference Numerals Used in the Drawings.

| ID. | Component |
|---|---|
| 1. | Captive doorframe assembly |
| 2. | Captive doorframe hinge stile member |
| 3. | Captive doorframe head member |
| 4. | Captive doorframe capture stile member |
| 5. | Door |
| 6. | Multiaxial control hinge mechanism |
| 7. | Doorframe hinge stile capture channel |
| 8. | Doorframe capture stile capture channel |
| 9. | Door hinge stile |
| 10. | Door capture stile |
| 11. | Primary hinge sub assembly |
| 12. | Upper primary hinge plate assembly |
| 13. | Lower Primary hinge plate assembly |
| 14. | Primary hinge torque bar |
| 15. | Upper door pivot housing |
| 16. | Lower door pivot housing |
| 17. | Upper primary pivot block |
| 18. | Lower primary pivot block |
| 19. | Primary pivot axis |
| 20. | Secondary pivot axis |
| 21. | Upper door pivot assembly |
| 22. | Lower door pivot assembly |
| 23. | Upper door pivot pin |
| 24. | Lower door pivot pin |
| 25. | Upper bar pivot shaft |
| 26. | Lower bar pivot shaft |
| 27. | Latch Operating Cam |
| 28. | Upper coupling plate |
| 29. | Latch assembly base plate 29 |
| 30. | Hinge locking pin |
| 31. | Upper Hinge torque bar housing |
| 32. | Latch arm Pivot pin |
| 33. | Latch arm |
| 34. | Latch operating arm pivot pin |
| 35. | Latch operating arm |
| 36. | Latch spring |
| 37. | Lower hinge torque bar housing |
| 38. | Lower door pivot housing |
| 39. | Lower door hinge plate |
| 40. | Captive doorframe capture stile member |
| 41. | Lower door pivot pin |
| 42. | Locking pin capture recess |
| 43. | Hinge locking plate |
| 44. | Hinge locking plate pivot pin |
| 45. | Roller guide recess |
| 46. | Locking arm pivot pin |
| 47. | Locking arm |
| 48. | Hinge locking plate catch surface |
| 49. | Locking arm spring |
| 50. | Lower door pivot pin |
| 51. | Lower door pivot plate |
| 52. | Locking arm operating surface |
| 53. | Latch operating arm contact surface |
| 54. | Torque bar assembly |
| 55. | Doorframe head movement guide roller |
| 56. | Primary hinge latch assembly |

The foregoing describes only one embodiment of the present invention and modifications, obvious to those skilled in the art, can be made thereto without departing from the scope of the present invention.

The term “comprising” (and its grammatical variations) as used herein is used in the inclusive sense of “including” or “having” and not in the exclusive sense of “consisting only of”.

1. A poly-axial closure hinge comprising:
a primary hinge assembly defining a primary pivot axis and configured to extend intermediate a closure head frame and a lower end proximal to a floor surface, the primary hinge configured to have a closure rotatably mounted thereto such that the closure is movable thereabout between a closed position covering an opening and an open position;
a secondary hinge having a secondary pivot axis defined by the primary hinge and configured to extend along or proximal to an edge of the closure, the second pivot axis being substantially parallel to and spaced apart from the primary hinge axis; and
a hinge locking assembly configured to fix movement of the primary and secondary hinges relative to each other about the secondary pivot axis when moved from the closed position and allow limited movement of the secondary binge relative to the primary hinge when in the closed position, the hinge locking assembly including:
a rotatably mounted hinge locking plate movable between a locked position and an unlocked position in response to the primary hinge and secondary hinge rotation about the secondary pivot axis, the hinge locking plate including a locking pin recess;
a locking pin fixed with respect to the primary hinge assembly and spaced apart from the secondary pivot axis, the locking pin configured to reside within the hinge locking plate recess to limit the orientation of the primary hinge relative to the secondary hinge when moved from the closed position; and
a rotatably mounted hinge locking plate arm movable between a locked and unlocked position in response to rotation of the primary hinge about the primary pivot axis from the closed position.

2. The poly-axial closure hinge according to claim 1 wherein the closure is a door or window and the opening is a door frame or a window frame.

3. The poly-axial closure hinge according to claim 1 wherein the hinge locking assembly includes a primary assembly associated with a marginal edge of the closure frame and a secondary assembly associated with a marginal edge of the closure.

4. The poly-axial closure hinge according to claim 1 wherein the hinge locking assembly locking pin is disposed in a fixed location with respect to the primary hinge assembly and the pin causes hinge locking plate movement between the locked and unlocked positions when the closure is move to and from the closed captive position.

5. The poly-axial closure hinge according to claim 1 wherein the hinge locking assembly includes a hinge locking plate locking arm rotatably mounted which is configured for movement between the locked position wherein the hinge locking plate locking arm locks the hinge locking plate, and the unlocked position where the hinge locking plate locking arm is spaced apart from the hinge locking plate, the hinge locking plate locking arm is moved between the locked and unlocked position in response to rotation about the primary hinge axis causing the hinge plate locking arm to move respectively into disengagement from and engagement with the hinge stile capture; a latching mechanism including the latch operating arm rotationally mounted and configured to move the pivotally mounted latch arm into the locked position when the closure is not in the closed position, and allow the said latch arm to move to the unlocked position when the closure is in the closed position; the latch arm in the locked position prevents the said hinge locking plate locking arm from moving to the unlocked position and the latch arm in the unlocked position allows the hinge locking plate locking arm to move to the unlocked position.

6. The poly-axial closure hinge according to claim 5 wherein the latch arm is moved by a cam plate disposed about the primary hinge.

7. The poly-axial closure hinge according to claim 1 wherein when the hinge locking plate locking arm in the locked position with the hinge locking plate locking arm engaged, the primary hinge is locked relative to the secondary hinge in a rigid position relative to each and the closure is restrained from movement about the secondary pivot axis.

8. The poly-axial closure hinge according to claim 1 including a roller guide disposed on a marginal edge of the closure such that when the closure is in the closed position the roller guide is adjacent a roller disposed on and extending from an adjacent closure frame wherein the roller guide is configured to move the closure into a position where the hinge locking plate locking arm engages with and locks the hinge locking plate as the closure moves towards the open position.

9. The poly-axial closure hinge according to claim 1 wherein with the closure in the closed position the hinge locking assembly allows limited movement of the closure in the plane thereof.

10. The poly-axial closure hinge according to claim 1 wherein the hinge locking plate locking arm is resiliently biased into the locked position.

11. The poly-axial closure hinge according to claim 6 wherein the latch arm is resiliently biased into the unlocked position.

12. The poly-axial closure hinge according to claim 1 wherein the primary hinge includes an elongate torque bar to maintain the secondary pivot axis substantially parallel to and separate from the primary pivot axis.

13. The poly-axial closure hinge according to claim 1 mounted to, or adjacent to, a closure frame hinge stile and extending from an upper end at or adjacent the closure frame head to a lower end at or adjacent a closure frame lower end.

14. The poly-axial closure hinge according to claim 1 the wherein the hinge locking plate locking arm of the hinge locking assembly includes a latch face to engage with the locking arm to thereby lock the hinge locking plate.

15. The poly-axial closure hinge according to claim 1 wherein the hinge locking assembly further includes a latching mechanism movable in response to rotation about the primary pivot axis from the closed position to prevent movement of the hinge locking plate locking arm to the unlocked position when the closure is not in the closed position.

16. The poly-axial closure hinge according to claim 1 wherein the hinge locking assembly includes an upper hinge locking assembly and a spaced apart lower hinge locking assembly.
